(19) United States
(12) Patent Application Publication
(10) Pub. No.: US 2015/0210909 A1
(43) Pub. Date: Jul. 30, 2015

(54) WEATHER-RESISTANT SILICONE MIXTURE HAVING IMPROVED GREEN STRENGTH

(71) Applicant: SIKA TECHNOLOGY AG, Baar (CH)

(72) Inventors: Christian Von Malotki, Bad Goisern am Hallstatter See (AU); Manuel Friedel, Zurich (CH)

(21) Appl. No.: 14/419,451

(22) PCT Filed: Jul. 30, 2013
(86) PCT No.: PCT/EP2013/065974

§ 371 Date: Feb. 3, 2015

(30) Foreign Application Priority Data
Aug. 10, 2012 (EP) 12180082.5

(51) Int. Cl. C09J 183/06; C08K 3/04; B29C 39/12; C08K 3/26; B29C 39/00; C08K 5/5419; C08K 3/36

(52) U.S. Cl. CPC C09J 183/06; C08K 5/5419; C08K 3/04; C08K 3/36; C08K 3/26; B29C 39/003; B29C 39/126; C08K 2003/045; C08K 2003/265; B29L 2009/00

(57) ABSTRACT

A one- or two-component silicone formulation, preferably an RTV silicone formulation, is described that has: a) at least one poly(diorganosiloxane), b) at least one first filler having an average particle size D50 less than or equal to 0.1 μm, c) at least one second filler having an average particle size D50 in the range of greater than 0.1 μm to 10 μm, and d) at least one cross-linking agent for the poly(diorganosiloxane). The constituents of the formulation can be present in one component, in the case of the one-component silicone formulation, and can be divided into two components A and B, in the case of the two-component silicone formulation. The silicone formulation is suitable in particular as an elastic adhesive for structural adhesive attachment, in particular in the facade, insulated glass, window construction, automotive, solar and construction fields. The silicone formulations have a high degree of green strength and are extraordinarily weather-resistant in the cured state.

### TECHNICAL FIELD

The invention relates to a one- or two-component silicone formulation, to the use thereof, and to a method for producing an arrangement in which a space between two substrates is filled with the one- or two-component silicone formulation.

### PRIOR ART

It is known that two-component RTV silicones can be formulated to have good weather resistance. International facade standards such as EOTA ETAG 002 demand certain stability levels after artificial, accelerated weathering. Silicone formulations having excellent rheological properties, which is to say in particular formulations having high early strength or stability in the uncured state, which then result in reduced “slip down,” frequently do not meet these requirements in regard to weather resistance.

It is also known that silicone formulations having high early strength can be obtained by adjusting the reactivity and promoting very fast full curing and/or by drastically increasing the viscosity of the mixture. The drawback in both cases is lacking or more difficult processability.

U.S. Pat. No. 4,563,498 describes one-component formulations that contain a—certain ratio of reinforcing filler and extending filler and that, after curing, result in low modulus elastomers. Silicone formulations are known from GB-B-2306491, which contain silica as the filler and remain sprayable and also have improved mechanical properties. WO-A-2012/041952 describes two-component silicone formulations that, after the components have been mixed, result in increased viscosity, wherein the formulation can contain pyrogenic, hydrophobic silica as the filler.

U.S. Pat. No. 6,235,832 and U.S. Pat. No. 5,840,794 are directed to one-component silicone formulations that achieve improved green strength. DE-A-102004005221 describes mixtures of silicone and silicic acid having a low yield value, in which pyrogenic silicic acid is used as the filler.

No silicone formulation is known that combines excellent early strength, measured as reduced “slip down,” with good processability, measured as a low yield point, and excellent resistance to weathering.

### DESCRIPTION OF THE INVENTION

It is the object of the present invention to provide a silicone formulation, and more particularly a moisture-curing silicone formulation, which has a low yield point and achieves high green strength and which has particularly weather-resistant mechanical properties.

Surprisingly, it has been found that these properties can be achieved with a silicone formulation if fillers having an average particle size of smaller than or equal to 0.1 μm and fillers having an average particle size of larger than 0.1 μm to smaller than or equal to 10 μm are used in combination in the formulation.

The present invention thus relates to a one- or two-component silicone formulation, comprising:
a) at least one poly(diorganosiloxane);
b) at least one first filler having an average particle size D50 of smaller than or equal to 0.1 μm;
c) at least one second filler having an average particle size D50 in the range of larger than 0.1 μm to 10 μm; and
d) at least one cross-linking agent for the poly(diorganosiloxane); and
e) optionally at least one condensation catalyst and/or
f) optionally at least one additive, selected from the group consisting of plasticizers, rheology auxiliaries, thickeners, adhesive promoters, catalysts, accelerators, drying agents, odorants, pigments, biocides, stabilizers and surfactants,
   wherein the constituents are present in one component in the case of the one-component silicone formulation, and are present divided into two components A and B in the case of the two-component silicone formulation.

Substance names beginning with “poly” herein represent substances that, per molecule, formally comprise two or more of the functional groups occurring in their names. A polyol is a compound having two or more hydroxy groups, for example. The term “polymer” herein comprises, on the one hand, a pool of macromolecules that are chemically defined, but may differ in terms of degree of polymerization, molar mass and chain length, the pool being obtainable by a polyreaction (such as polymerization, polyaddition, polycondensation) of one or more monomers. On the other hand, the term also includes derivatives of such a pool of macromolecules from polyreactions, which is to say compounds that were obtained by reactions, for example additions or substitutions, of functional groups on predetermined macromolecules and which may or may not be chemically defined. The term additionally includes what are known as prepolymers, which is to say reactive oligomers, the functional groups of which are involved in the creation of macromolecules.

The term “heteropolyethers” herein shall be understood to mean polymers having a polyether-equivalent structure, which partially or completely contain heteroatoms, such as S, in place of the ether oxygen atoms.

The “relative molar mass” herein shall be understood to mean the number average relative molar mass (Me).

The “room temperature” shall be understood to mean a temperature of 23° C.

Unless indicated otherwise, weight information refers to the entire formulation, which is to say to the entire weight of components A and B in the case of a two-component formulation.

The silicone formulation according to the present invention is a one- or two-component silicone formulation, which is suitable as an adhesive or sealant, for example. A person skilled in the art will be very familiar with such one- or two-component formulations.

Only one component is present in the case of the one-component formulation, which is to say all the constituents of the formulation are contained in this component and are present therein as a mixture.

A two-component silicone formulation is composed of a kit having two separate components A and B. The various constituents of the formulation are divided among these two components, which is to say the constituents are present in component A and/or in component B. In general, a constituent is present in only one of the two components. However, it is optionally also possible for one or more constituents to be present in both components A and B. The two components A and B of the two-component formulation are mixed with each other at an appropriate ratio prior to use.

The one- or two-component silicone formulations according to the invention are preferably free-flowing silicone formulations, wherein in the case of two-component formulations this also refers to the mixture that is obtained after the two components have been combined. Naturally, this refers to the state during use, which is to say when applying it to a substrate or when filling it in a space. The system then solidifies during subsequent curing. The one- or two-component silicone formulations according to the invention, and preferably the free-flowing silicone formulations, are further preferably moisture-curing silicone formulations. The silicone formulations can be silicone rubbers or silicone elastomers.

The one- or two-component silicone formulation is in particular a cold-curing silicone formulation, which is typically referred to as an RTV (room temperature vulcanizing) silicone formulation. This may be a one-component silicone formulation, which is also referred to as an RTV-1 silicone or RTV-1 silicone rubber. These are generally moisture-curing formulations. As an alternative, it is a two-component silicone formulation (RTV-2 silicone or RTV-2 silicone rubber). RTV-1 and RTV-2 silicone rubbers are used extensively as adhesives or sealants.

A two-component silicone formulation is preferred.

The constituents of the one- or two-component silicone formulation will be described hereafter.

The silicone formulation comprises one or more cross-linkable poly(diorganosiloxanes) (constituent a). Cross-linking may be carried out via reactive end groups or by end groups of the poly(diorganosiloxanes) that can be converted into reactive groups. All customary poly(diorganosiloxanes) can be used. For example, such poly(diorganosiloxanes) are known well for the production of adhesives or sealants, such as RTV silicone rubber, and are commercially available.

The poly(diorganosiloxane) can preferably be a poly(diorganosiloxane) having hydroxyl end groups and/or can be a poly(diorganosiloxane) having alkoxysilyl end groups. Hydroxyl-group-terminated poly(diorganosiloxanes) are known and commercially available. The production of such poly(diorganosiloxanes) is also carried out in the known manner. It is described in U.S. Pat. No. 4,962,152, for example, the disclosure of which is hereby incorporated by reference.

The poly(diorganosiloxane) is preferably a poly(dialkylsiloxane), wherein the alkyl radicals preferably have 1 to 5, and more preferably 1 to 3, carbon atoms, and particularly preferably are methyl groups.

The viscosity of the poly(diorganosiloxanes) used may vary within broad ranges. The poly(diorganosiloxane) or poly(diorganosiloxanes) used preferably has or have a viscosity of 10 to 500,000 mPa·s, more preferably of 5,000 to 350,000 mPa·s, particularly preferably of 6,000 to 120,000 mPa·s, and most preferably of 10,000 to 80,000 mPa·s, at a temperature of 23° C. The viscosity is determined according to the method described in the experimental part.

Preferably one or more polydiorganosiloxanes with the formula (I) are used

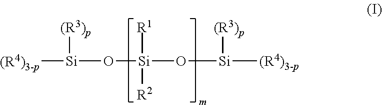

where
the groups R¹, R² and R³ independently of one another represent linear or branched monovalent hydrocarbon groups having 1 to 12 carbon atoms, which optionally include one or more heteroatoms, and optionally one or more carbon-carbon multiple bonds and/or optionally cycloaliphatic and/or aromatic fractions or groups; the groups R⁴ independently of one another represent hydrogen, hydroxyl groups, or alkoxy, acetoxy or ketoxime groups, each having 1 to 13 carbon atoms, which optionally include one or more heteroatoms, and optionally one or more carbon-carbon multiple bonds and/or optionally cycloaliphatic and/or aromatic fractions or groups, wherein the groups R⁴ preferably represent hydroxyl groups or alkoxy groups; the subscript p represents a value of 0, 1 or 2; and the subscript m is selected so that the poly(diorganosiloxane) has a viscosity of 10 to 500,000 mPas at a temperature of 23° C.

In the poly(diorganosiloxane) with the formula (I), the groups R¹ and R² preferably represent alkyl radicals having 1 to 5, and more particularly 1 to 3, carbon atoms, and preferably they represent methyl groups.

If the poly(diorganosiloxane) with the formula (I) is a hydroxyl-group-terminated poly(diorganosiloxane) (R⁴=hydroxyl group), the subscript p in particular represents a value of 2.

If the poly(diorganosiloxane) with the formula (I) is a poly(diorganosiloxane) having alkoxy, acetoxy or ketoxime end groups (R⁴=alkoxy, acetoxy or ketoxime group), the subscript p preferably represents a value of 0 or 1. In these poly(diorganosiloxanes), R⁴ preferably represents ketoxime groups, or particularly preferably alkoxy groups. If a two-component silicone formulation is present, in which component A contains a poly(diorganosiloxane) having alkoxy, acetoxy or ketoxime end groups, then component A preferably additionally contains water.

Preferred alkoxy groups are methoxy, ethoxy or isopropoxy groups. Preferred ketoxime groups are dialkyl ketoxime groups, in which the alkyl groups in each case have 1 to 6 carbon atoms. The two alkyl groups of the dialkyl ketoxime groups preferably independently of one another represent methyl, ethyl, n-propyl, iso-propyl, n-butyl or iso-butyl groups. Particularly preferred are those cases in which one alkyl group of the dialkyl ketoxime represents a methyl group, and the other alkyl group of the dialkyl ketoxime represents a methyl, ethyl or an iso-butyl group. Most preferably, the ketoxime group represents an ethyl methyl ketoxime group.

The one- or two-component silicone formulation furthermore includes at least one first filler having an average particle size of smaller than or equal to 0.1 μm (constituent b) and at least one second filler having an average particle size in the range of larger than 0.1 μm to 10 μm (constituent c).

One or more fillers that independently of one another may differ from each other in terms of the material and/or the average particle size can be used for both the first and the second filler. The first and second fillers are also preferably completely present in one of the two components in the case of the two-component silicone formulation. In principle, however, the two fillers can also be present in each case in different components, or a portion of the first filler and/or of the second filler is present in the respective other component; however, this is not preferred.

The one- or two-component silicone formulation preferably includes at least one first filler in which the average particle size D50 of the primary particles is 5 to 100 nm, preferably 10 to 100 nm, more preferably 10 to 80 nm, in particular 15 to 90 nm, and most particularly preferably 15 nm to 50 nm, and at least one second filler in which the average particle size D50 of the primary particles is larger than 0.1 μm to 10 μm, for example 0.3 μm to 10 μm, preferably 0.5 μm to 10 μm, more preferably 1 μm to 10 μm, in particular 1 μm to 8 μm, and particularly preferably 2 μm to 6 μm. The average particle size is the D50 value of the primary particles. The D50 value is the value of the particle size distribution at which exactly 50% of the present particles are larger and 50% of the present particles are smaller, wherein the D50 value refers to the number average. The particle size distributions can be ascertained here by way of laser diffraction according to ISO 13320 for particles larger than or equal to 0.1 μm, or by way of dynamic light scattering according to ISO 22412 for particles smaller than 0.1 μm. Another measuring method for particles smaller than 0.1 μm is photon correlation spectroscopy according to ISO 13321.

In the one- or two-component silicone formulation, the weight ratio between fillers having an average particle size D50 of smaller than or equal to 0.1 μm, or for the first filler, and fillers having an average particle size D50 of larger than 0.1 μm to smaller than or equal to 10 μm, or for the second filler, is preferably in the range of 10:1 to 1:2, still more preferably 10:1 to 1:1, still more preferably 10:1 to 2:1, more preferably in the range of 9:1 to 3:1, and particularly preferably in the range of 8:1 to 4:1, wherein ranges of 6.5:1 to 1:1 and 6.5:1 to 2:1 are likewise preferred. In this way, improved green strength and increased resistance to weathering of the cured formulation can be achieved.

For the first filler, one or more, preferably multiple, fillers, in particular two, three or more fillers, are used in which the average particle size D50 of the primary particles is smaller than or equal to 0.1 μm, preferably the average particle size D50 of the primary particles is 5 nm to 100 nm, and more preferably 10 nm to 80 nm. For the second filler, one or more fillers, and preferably one, two or more fillers, are used in which the average particle size D50 of the primary particles is larger than 0.1 μm to 10 μm, for example 0.3 μm to 10 μm, preferably 0.5 μm 10 μm, more preferably 1 μm to 10 μm, and in particular 1 μm to 8 μm. The weight ratio of the first filler to the second filler is preferably in the range of 10:1 to 1:2, still more preferably 10:1 to 1:1, still more preferably 10:1 to 2:1, more preferably in the range of 9:1 to 3:1, and particularly preferably in the range of 8:1 to 4:1, wherein ranges of 6.5:1 to 1:1 and 6.5:1 to 2:1 are likewise preferred.

Suitable materials for the fillers are all fillers that are typically used in the art, both for the first filler and for the second filler. The first and second fillers can be made of the same material, but are usually made of different materials.

Examples of suitable fillers are inorganic and organic fillers, for example carbonates, pyrogenic and/or precipitated metal and/or metalloid oxides or hydroxides, or mixed oxides thereof, sulfates, carbides, nitrides, silicates, glass, carbon modifications, natural minerals, silicic acids, silica or carbon black types. Specific examples are natural, ground or precipitated calcium carbonates, such as chalks, which are optionally coated with fatty acids, in particular stearic acid, calcined kaolins, aluminum oxides, aluminum hydroxides, silica, silicic acids, in particular finely dispersed silicic acids from pyrolysis processes, carbon black, in particular industrially produced carbon black, silicates such as aluminum silicates, magnesium aluminum silicates, zirconium silicates, quartz powder, cristobalite powder, diatomaceous earth, mica, iron oxides, titanium oxides, zirconium oxides, gypsum, unburnt plaster, barium sulfate, boron carbide, boron nitride, graphite, carbon fibers, glass or hollow glass spheres.

Suitable silicic acids also include hydrophobic silicic acids, and more particularly hydrophobic, pyrogenic silicic acid. Suitable hydrophobic silicic acids typically have a BET surface area in the range of 100 to 300 m²/g. The BET surface area is determined according to EN ISO 18575, for example.

Suitable hydrophobic silicic acids can be produced, for example, by the hydrophobization of hydrophilic silicic acids with organosilanes or organosiloxanes, such as octamethylcyclotetrasiloxane, polydimethylsiloxane, dimethyldichlorosilane or hexamethyldisilazane. Suitable hydrophobic silicic acids are commercially available from Evonik Degussa GmbH, Germany, from Cabot Corporation, USA, or from Wacker Chemie AG, Germany, for example.

Preferred fillers are calcium carbonates, in particular natural or precipitated chalks, calcined kaolins, carbon black, silica, silicic acids, in particular finely dispersed silicic acids, silicon dioxide, titanium dioxide, aluminum oxides, iron oxides, flame retardant fillers such as hydroxides or hydrates, in particular hydroxides or hydrates of aluminum, preferably aluminum hydroxide.

A suitable amount of filler, including the first and second fillers, for example, ranges from 10 to 70% by weight, in particular 15 to 60% by weight, preferably 30 to 60% by weight, and in particular 41 to 60% by weight, based on the total one- or two-component silicone formulation.

The formulation further includes one or more cross-linking agents for poly(diorganosiloxanes) (constituent d), which can be all cross-linking agents known in technology for this purpose.

For example, the cross-linking agent is preferably selected from a tetraalkoxysilane, organotrialkoxysilane, diorganodialkoxysilane and/or oligo(organoalkoxysilane), tetrakis ketoximosilane, organotris ketoximosilane, diorganobis ketoximosilane and/or oligo(organoketoximosilane), which are optionally functionalized with one or more heteroatoms in the organyl group, or mixtures thereof.

The cross-linking agent for polydiorganosiloxanes is preferably a silane with the formula (II).

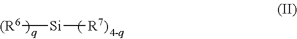

Group R⁶ independently of one another represents a group as it was defined above for R³ in the poly(diorganosiloxane) with the formula (I). R⁶ is, of course, independent of the meaning of R³ in the poly(diorganosiloxane). Group R⁷ independently of one another represents a group as it was defined above for R⁴ in the poly(diorganosiloxane) with the formula (I). R⁷ is, of course, independent of the meaning of R⁴ in the poly(diorganosiloxane). The groups R⁷ preferably represent alkoxy or ketoxime groups, as they were described above.

Moreover, the subscript q represents a value of 0 to 4, with the proviso that, if q is a value or 3 or 4, at least q-2 groups R⁶ in each case include at least one group that is reactive with the hydroxyl, alkoxy, acetoxy or ketoxime groups of the poly(diorganosiloxane). In particular, q represents a value of 0, 1 or 2, and preferably a value of 0 or 1.

Examples of suitable silanes with the formula (II) are methyltrimethoxysilane, chloromethyltrimethoxysilane, ethyltrimethoxysilane, propyltrimethoxysilane, vinyltrimethoxysilane, methyltriethoxysilane, vinyltriethoxysilane, phenyltriethoxysilane, methyltripropoxysilane, phenyltripropoxysilane, tetramethoxysilane, tetraethoxysilane, tetra-n-propoxysilane, tetra-n-butoxysilane, methyltris(methyl-ethylketoximo)silane, phenyltris(methyl-ethylketoximo)silane, vinyltris(methyl-ethyl-ketoximo)silane, methyltris(isobutylketoximo)silane or tetra(methyl-ethylketoximo)silane. Methyltrimethoxysilane, vinyltrimethoxysilane, tetraethoxysilane, methyltris(methyl-ethylketoximo)silane, vinyltris(methyl-ethylketoximo)silane and methyltris(isobutylketoximo)silane are particularly preferred. Preferred ketoximosilanes are frequently commercially available, for example from ABCR GmbH & Co, Germany, or from Nitrochemie AG, Germany.

Moreover, the silanes with the formula (II) can also already be present in partially (some of all R⁷=OH) or completely hydrolyzed form (all R⁷=OH). Due to the drastically increased reactivity of partially or completely hydrolyzed silanes, the use thereof as a cross-linking agent can be advantageous. It is known to a person skilled in the art that the use of partially or completely hydrolyzed silanes may result in the formation of oligomeric siloxanes, and more particularly dimers and/or trimers, which are formed by the condensation of hydrolyzed silanes.

Particularly preferred oligomeric siloxanes are, for example, hexamethoxydisiloxane, hexaethoxydisiloxane, hexa-n-propoxydisiloxane, hexa-n-butoxydisiloxane, octaethoxytrisiloxane, octa-n-butoxytrisiloxane and decaethoxy tetrasiloxane.

Of course it also possible to use any arbitrary mixtures of the above-mentioned silanes as the cross-linking agent for poly(diorganosiloxanes).

The content of the cross-linking agent for poly(diorganosiloxanes) is preferably 0.1 to 15% by weight, in particular 1 to 10% by weight, and preferably 2 to 6% by weight-, based on the total one- or two-component silicone composition.

As an optional constituent, the silicone formulation, and more particularly the two-component silicone formulation, can further include one or more condensation catalysts (constituent e). This serves as a catalyst for cross-linking the polydiorganosiloxanes. Preferred condensation catalysts are organyl compounds and/or metal or metalloid complexes, in particular from the groups Ia, IIa, IIIa, IVa, IVb or IIb of the periodic table of elements, such as Sn compounds, Ti compounds, for example titanates, and borates, or mixtures thereof.

Preferred organotin compounds are dialkyltin compounds, for example selected from dimethyltindi-2-ethylhexanoate, dimethyl tin dilaurate, di-n-butyltin diacetate, di-n-butyltindi-2-ethylhexanoate, di-n-butyltin dicaprylate, di-n-butyltindi-2,2-dimethyloctanoate, di-n-butyltin dilaurate, di-n-butyltin-distearate, di-n-butyltin dimaleinate, di-n-butyltin dioleate, di-n-butyltin diacetate, di-n-octyltindi-2-ethylhexanoate, di-n-octyltindi-2,2-dimethyloctanoate, di-n-octyltin dimaleinate, and di-n-octyltin dilaurate.

Titanates or organotitanates refer to compounds that have at least one ligand bound to the titanium atom by an oxygen atom. Suitable ligands bound to the titanium atom by an oxygen-titanium bond include those which are selected from the group consisting of the alkoxy group, sulfonate group, carboxylate group, dialkylphosphate group, dialkylpyrophosphate group and acetylacetonate group. Preferred titanates are, for example, tetrabutyl or tetraisopropyl titanate. Additional suitable titanates include at least one multidentate ligand, also known as a chelate ligand. The multidentate ligand is in particular a bidentate ligand.

Suitable titanates are commercially available under the trade names Tyzor® AA, GBA, GBO, AA-75, AA-65, AA-105, DC, BEAT, IBAY from DorfKetal, India.

Of course it is possible, or in certain cases even preferred, to use mixtures of various catalysts. For example, a preferred catalyst is a mixture of an organotin compound with a titanate.

The content of the condensation catalyst for cross-linking poly(diorganosiloxanes) can vary within broad ranges; however, if used, it is preferably 0.001 to 10% by weight, in particular 0.005 to 4% by weight, and preferably 0.01 to 3% by weight, based on the total one- or two-component silicone formulation.

The one- or two-component silicone formulation can further optionally comprise one or more additives (component f), selected from plasticizers, rheology auxiliaries, thickeners, adhesive promoters, catalysts, accelerators, drying agents, odorants, pigments, biocides, stabilizers and surfactants, but also processing auxiliaries, dyes, inhibitors, heat stabilizers, antistatic agents, flame retardants, waxes, flow enhancers, thixotropic agents, and additional common additives known to the person skilled in the art. All customary additives that are known in the art can be used for this purpose. When such optional constituents are used, it is important to ensure that constituents that could impair the storage stability of the composition as a result of reacting with each other or with other ingredients are stored separately from each other.

Suitable additives, in particular plasticizers and adhesive promoters, which can be contained in the silicone formulation, are described, for example, in paragraphs [0051] to [0055] of the patent application US-A1-2010/063190, the entire disclosure of which is hereby incorporated by reference.

In particular water-soluble or water-swellable polymers or inorganic thickeners are used as thickening agents, for example. Examples of organic natural thickeners are agar-agar, carrageenan, tragacanth, gum arabic, alginates, pectins, polyoses, guar flour, starch, dextrins, gelatin or casein. Examples of organic fully or partially synthetic thickeners are carboxymethyl cellulose, cellulose ether, hydroxy ethyl cellulose, hydroxyl propyl cellulose, poly(meth)acrylic acid derivatives, poly(meth)acrylates, polyvinyl ether, polyvinyl alcohol or polyamides. Thickeners are used in two-component formulations in particular in component B when component A is a poly(diorganosiloxane) in which the groups R⁴ represent alkoxy, acetoxy or ketoxime groups, in particular when component B also contains water. The one- or two-component silicone formulation can optionally include further ingredients and additives, such as end-capped silicone oils, for example having a viscosity of 10 to 1,000 mPas (determined according to the method described in the experimental part), amino-functionalized oligosiloxanes, polyamines, polyethers, heteropolyethers and/or polyetheramines. The end-capped silicone oils are not suitable for cross-linking and can be present in one or both components of the two-component formulation. They are suitable for adjusting the viscosity, for example. Such end-capped silicone oils correspond to compounds with the general formula (I), where R¹, R² and R³ independently of one another have the meanings described above, p has a value of 3, and m is selected so that a viscosity of 10 to 1,000 mPas is adjusted.

The silicone formulation, in particular the two-component silicone formulation, can comprise at least one additive, for example, selected from polyamine, polyether, heteropolyether and polyetheramine. Derivatives of these compounds are also suitable additives. The additive in particular additionally has at least one functional group with the formula —XH, where X represents 0, S or NR⁵, and R⁵ represents a hydrogen atom or a linear or branched, monovalent hydrocarbon group having 1 to 20 carbon atoms. Suitable additives moreover preferably have a relative molar mass in the range of 100 to 10,000 g/mol.

The additive is preferably a polyamine or polyetheramine. Suitable polyamines are in particular polyalkylene imine, such as polyethylene imine or polypropylene imine, or alkxoylated polyamine, such as ethoxylated and/or propoxylated ethylene diamine. Suitable polyetheramines are polyoxyethylene amine, polyoxypropylene amine or polyoxyethylene-polyoxypropylene amine. Polyethermonoamines, polyetherdiamines or polyethertriamines are particularly preferred polyetheramines. The amino groups can be primary, secondary or tertiary amino groups. The amino groups are in particular primary or secondary amino groups.

Suitable polyetheramines are commercially available, for example, under the trade name Jeffamine® from Huntsman Corporation, USA. Jeffamines® of the M, D, ED, DER, T, SD or ST series are particularly suited.

The content of the above-described additive, if used, is 0.05 to 5% by weight, for example, in particular 0.1 to 3% by weight, and preferably 0.2 to 1.5% by weight, based on the total one- or two-component silicone formulation.

This additive is suitable with two-component silicone formulations, for example, wherein the fillers and the additive are contained in each case in one of the two separate components of the two-component silicone compositions. When the two components are combined, this can result in an increase in viscosity of more than 100% compared to the initial viscosity of the component of the two-component silicone composition which has the higher viscosity.

The one- or two-component silicone formulation according to the invention preferably does not contain the following polydiorganosiloxane A1):

A1) a polydiorganosiloxane, including at least one chain end group per molecule, which comprises a multi-alkoxysilyl group with the following formula

—Z_{b}—R⁴(Z—SiR²ₙ(OR³)₃₋ₙ)ₐ

where R² is independently selected from the group consisting of a hydrogen atom and monovalent hydrocarbon groups comprising 1 to approximately 18 carbon atoms, R³ is an independently selected alkyl group comprising 1 to approximately 8 carbon atoms, Z is independently selected from the group consisting of divalent hydrocarbon groups comprising approximately 2 to 18 carbon atoms and a combination of divalent hydrocarbon groups and siloxane segments described by the formula

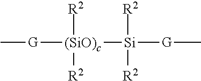

where R² is as defined above, and G is an independently selected divalent hydrocarbon group comprising approximately 2 to 18 carbon atoms, c is an integer from 1 to approximately 6, x is 0 or 1, and y is 0 or 1, R⁴ is independently selected from the group consisting of a silicon atom and a siloxane group comprising at least two silicon atoms, and each Z is bound to a silicon atom of R⁴, wherein the remaining valencies of the silicon atoms of R⁴ are bound to a hydrogen atom, a monovalent hydrocarbon group comprising 1 to approximately 18 carbon atoms or form siloxane compounds, n is 0, 1 or 2, a is at least 2, and b is 0 or 1, with the proviso that R⁴ is bound to the polydiorganosiloxane via a siloxane bond when b is 0.

The one- or two-component silicone formulation according to the invention further preferably does not contain the following polymer A2) and/or the following polydimethylsiloxane A3):

A2) a polymer with the formula

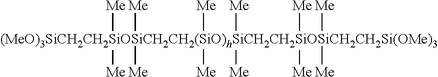

where h is at least 2,

A3) a polydimethylsiloxane with the formula

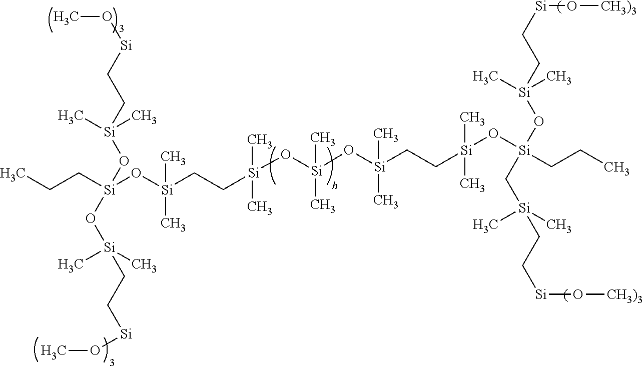

where h is at least 2.

The polydimethylsiloxane A3) can be produced according to U.S. Pat. No. 6,235,832 B1 as follows:

203 g (0.686 mol) tris(dimethylsiloxy)-n-propylsilane produced as described in the U.S. Pat. No. 5,446,185 and 5000 ppm of a solution of a platinum-vinylsiloxane complex containing 30 ppm platinum metal were heated to 100° C. The heat was then removed, and 150 g (1.01 mol) vinyltrimethoxysilane was added dropwise over a period of approximately 45 minutes while sufficiently stirring to maintain a crucible temperature of approximately 100 to 105° C. The analysis of the reaction mixture by way of gas-liquid chromatography (Hewlett Packard 5890 Series II using a flame ionization detector) showed a yield of approximately 40% of a multi-alkoxysilyl end cap compound (“end capper A”). The reaction mixture was distilled to yield 141 g end capper A with the following formula, boiling at 155° C. at a pressure of 0.5 mm Hg:

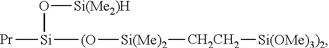

Next, 400 g of a vinyl end-blocked polydimethylsiloxane (PDMS) having a viscosity of 65 Pa·s, measured at 25° C. with a Brookfield rheometer and containing 0.012 mol vinyl, and 294 ppm of a solution of a platinum vinylsiloxane complex containing 1.8 ppm platinum metal were mixed for several minutes at 50° C. The heat was removed and 7.72 g (containing 0.012 mol hydrogen) end capper A, produced as described above, was then added, and mixing was continued for 1 hour. The mixture was vented at a vacuum of approximately 50 mm Hg and allowed to rest over night to react. The vinyl on the PDMS reacted with the SiH in the end capper, and no residual vinyl was discovered during the FT-IR analysis (Perkin Elmer 1600 Series).

Polydimethylsiloxanes, end-blocked with end capper A and having an overall viscosity of approximately 65 Pa·s, measured at 25° C. by way of a Brookfield rheometer, with the above-described formula for polydimethylsiloxane A3) were formed.

Polydiorganosiloxanes according to A1), A2) and A3) are described in U.S. Pat. No. 6,235,832 B1.

It is further advantageous that the one- or two-component silicone formulation according to the invention does not contain the following compound B1) and/or the following reaction mixture B2):

B1) a di(ethylacetoacetate)diisopropoxy titanate chelate;

B2) a reaction mixture made of a 2:1 molar mixture of glycidoxypropyl-trimethoxysilane and aminopropyltrimethoxysilane.

It is further preferred that the one- or two-component silicone formulations according to the invention exclude such formulations which contain a polydiorganosiloxane selected from a polymer A2) and a polydimethylsiloxane A3) as described above, a compound B1) as described above, a reaction mixture B2) as described above, and methyltrimethoxysilane.

It is further preferred that the one- or two-component silicone formulations according to the invention exclude the following formulations, with the information in % by weight referring to the above-described substances:

| | | |
|---|---|---|
| Polydimethylsiloxanes comprising polymers A2) | 56% | |
| having an overall viscosity of approximately 65 Pa · s, | | |
| measured at 25° C. by way of a Brookfield rheometer | | |
| Polydimethylsiloxanes A3) end-blocked with end capper | | 56% |
| A having an overall viscosity of approximately 65 Pa · s, | | |
| measured at 25° C. by way of a Brookfield rheometer, | | |
| produced as described above | | |
| Precipitated calcium carbonate treated with stearate | 35% | 35% |
| and having a particle size of approximately 0.075 | | |
| microns | | |
| Ground calcium carbonate treated with stearate and | 5% | 5% |
| having a particle size of approximately 3 microns | | |
| Compound B1) | 1% | 1% |
| Methyltrimethoxysilane | 2.5% | 2.5% |
| Reaction mixture B2) | 0.5% | 0.5% |

In a one-component silicone formulation, all the constituents are present in one component in the form of a mixture. In a two-component silicone formulation, two separate components A and B are present, each of which contains mixtures of some of the constituents. A person skilled in the art is already very familiar with such kits comprising two components. In a preferred embodiment, constituents a), b) and c) are present in the form of a mixture in the first component A, and constituent d) and, where necessary, the optional constituent e) are present in the second component B. The optional additive or additives f) is or are preferably present in component A, unless indicated otherwise above. However, if necessary, for example component B can also contain additives, constituents f), such as thickening agents, the above-described additives or the end-capped silicone oils, so as to control the viscosity.

It is furthermore advantageous to select all the described constituents that are optionally present in the two-component silicone formulation in such a way that the storage stability of the two components of the two-component silicone formulation is not adversely affected by the presence of such a constituent, which is to say that the properties of the composition, in particular the application and curing properties, do not change or change only little during storage. This requires that reactions which lead to the chemical curing of the described two-component silicone composition do not to take place to a significant degree during storage. In some cases it may be useful to chemically or physically dry certain constituents prior to mixing them into the composition.

Component A in two-component silicone compositions according to the invention typically has a viscosity in the range of 500 to 5,000 Pa·s, and more particularly of 500 to 3,000 Pa·s. Component B typically has a viscosity in the range of 1 to 5,000 Pa·s, and more particularly of 10 to 700 Pa·s. The viscosity is determined according to the method described in the experimental part.

Both the one-component silicone formulation and components A and B of the two-component silicone formulation are produced and stored in particular in the absence of moisture. The one-component formulation, or the two components A and B, are storage stable separately from each other, which is to say, they can be stored for a period of several months up to one year and longer in suitable packaging or in a suitable arrangement, without the application properties thereof, or the characteristics thereof, changing after curing to a degree that is relevant for their use. The storage stability is usually determined by measuring the viscosity or the reactivity over time.

The one- or two-component silicone composition is suitable as an adhesive, a sealant, a coating or a casting composition. It is suitable in particular for adhesive bonding, for sealing or for coating substances. For example, suitable substrates are selected from the group consisting of concrete, mortar, brick, clay brick, ceramics, gypsum, natural stone such as granite or marble, glass, glass ceramics, metal or metal alloy such as aluminum, steel, non-ferrous metal, galvanized metal, wood, plastic material such as PVC, polycarbonate, polymethyl(meth)acrylate, polyester, epoxy resin, dye and paint. Metals or metal alloys can be pretreated, for example by way of anodizing or galvanizing.

The silicone composition according to the invention is typically suitable as an adhesive or sealant, in particular for applications that require a composition having good initial strength and low slip. The silicone formulations are in particular suitable for window or facade construction, for the adhesive bonding and sealing of solar panels, and for use in vehicle construction. The one- or two-component silicone formulation according to the invention is suitable in particular as an elastic adhesive for structural adhesive attachment, in particular in the facade, insulated glass, window construction, automotive, solar and construction fields.

The invention thus also relates to a method for filling a space between two substrates so as to generate an arrangement, comprising a) providing a one- or two-component silicone formulation according to the invention, wherein the two components are mixed with each other in the case of a two-component silicone formulation, subsequently b1) applying the one-component silicone formulation or the mixed two-component silicone formulation to a first substrate, and bringing a second substrate in contact with the silicone formulation that has been applied to the first substrate, or b2) filling a space, which is formed as a result of arranging a first substrate and a second substrate, with the one-component silicone formulation or the mixed two-component silicone formulation. Thereafter, c) the applied or filled-in silicone formulation is cured.

If a one-component silicone formulation is used, the mixture is simply pressed out of or removed from the storage container, and is then applied or filled in. Curing generally takes place by the moisture in the surroundings. Curing preferably takes place at the ambient temperature, which is to say heating is not required.

When the two-component silicone formulation is applied or filled in, components A and B are mixed with one another, for example by way of stirring, kneading, rolling or the like, however in particular by way of a static mixer. The hydroxyl groups or the hydrolyzable groups of the poly(diorganosiloxane) then come in contact with the hydrolyzable, or optionally with already hydrolyzed, groups of the cross-linking agent, whereby the composition cures as a result of condensation reactions, which are promoted by the optional condensation catalyst, if necessary. The contact of the silicone formulation with water, in particular in the form of humidity, during the application or filling process can likewise favor the cross-linking process, since the reaction of the water with hydrolyzable groups causes the more reactive silanol groups to be formed. Curing of the two-component silicone composition preferably takes place at the ambient temperature, which is to say heating is not required.

When the one- or two-component silicone composition is cross-linked, by-products of the condensation reaction in particular include compounds that impair neither the formulation nor the substrate to which the formulation is applied or in which the formulation is filled. Most preferably, the by-products are compounds that easily volatilize from the cross-linking or already cross-linked formulation.

In the method according to the invention, the mixing of components A and B is preferably carried out so that the weight ratio of component A to component B is ≧1:1, in particular 3:1 to 15:1, and particularly preferably 10:1 to 14:1.

The one-component silicone formulation, or the mixture of the two components in the case of the two-component silicone formulation, is preferably free-flowing before or when it is applied to the first substrate, or when it is filled into the space formed between the two substrates, and particularly preferably has a viscosity in the range of 500 to 5,000 Pas. The viscosity can be determined according to the method listed in the experimental part. The one-component silicone formulation, or the mixture of the two components in the case of the two-component silicone formulation, further preferably has a yield point of less than 150 Pa, preferably of less than 100 Pa, and particularly preferably of less than 80 Pa, before or when it is applied to the first substrate, or before or when it is filled into the space formed between the two substrates. The corresponding testing method is described hereafter in the experimental part. A moisture-curing RTV silicone formulation, either one-component or two-component, is preferred, wherein a two-component formulation is preferred.

The silicone formulations according to the invention have a high degree of green strength after being applied or filled in, and are extraordinarily weather-resistant in the cured stated. The slip down as measure of the green strength is preferably in the range of 0 to 2 mm. The drop in tensile strength after artificial weathering as a measure of the weather resistance is preferably less than 25% for the cured formulation. The testing methods for this purpose are described in more detail in the experimental part.

The invention further relates to an arrangement, comprising a cured silicone formulation composed of the one-component silicone formulation, or of the mixture of the two components of the two-component silicone formulation, between two substrates. This arrangement can be obtained in particular by the method according to the invention.

### Examples

Several examples are listed hereafter, which further illustrate the invention, but are not intended to limit the scope of the invention in any way whatsoever. Unless indicated otherwise, all content and percentage information relates to the weight.

### Production of the Silicone Formulations

The silicone formulations listed in Table 1 are 2-component formulations. All quantity information refers to percent by weight of the total formulation (components A+B mixed at a ratio of 13:1 weight/weight). To produce component A, the indicated amount of OH-terminated poly(diorganosiloxane), ½ of the indicated amount of end-capped poly(diorganosiloxane), and the indicated amount of fillers were mixed with each other in a dissolver at room temperature under an inert atmosphere and stirred in until a macroscopically homogeneous paste was obtained. To produce component B, ½ of the indicated amount of end-capped poly(diorganosiloxane), the indicated amount of functional trialkoxysilane, and the indicated amount of Sn compound were mixed with each other in a dissolver at room temperature under an inert atmosphere and stirred in until a macroscopically homogeneous paste was obtained. Mixing with only fine fillers was not carried out because such mixtures are very difficult to process.

Directly after mixing, components A and B were filled separately into cartridges, stored in a hermetically sealed manner, and mixed with each other at a weight ratio A:B=13:1 in a dissolver under a vacuum immediately before being applied, until a macroscopically homogenous paste was obtained.

### Production of the Specimen and Description of the Testing Methods

Tensile Strength after Storage and after Storage with UV Treatment

The method for determining the tensile strength and the production of the specimen required for determination are described in EOTA ETAG 2 of January 2002. The measurement for the tensile test was carried out on test specimen measuring 12×12×50 mm, using anodized aluminum and float glass as the substrate. Aluminum was pretreated with Sika Aktivator® C-205 and float glass was pretreated with Sika® Cleaner P (both available from Sika Schweiz AG). The three specimen were stored for 1 day at 23° C./150% relative humidity, demolded, and stored for another 6 days at 23° C./50% relative humidity, and subsequently tested; three additional specimen were in each case additionally stored according to the described storage for 21 days in a Suntest XLS from Atlas at 55° C. in a water bath and irradiated with light having a wavelength of 300 to 800 nm at an intensity of 550 W/m². The tensile strength was tested in all cases at 23° C. and 50% relative humidity.

### Viscosity and Yield Point

Unless indicated otherwise, the viscosity was determined based on DIN 53018. The measurement of the viscosity was carried out by way of a Physica MCR101 cone and plate viscosimeter from Anton Paar, Austria, cone type CP 25-1, at a temperature of 23° C. The indicated viscosity values for poly(diorganosiloxanes) and end-capped silicone oils refer to a shear rate of 0.5 s⁻¹. The values indicated for component A, component B, and for the mixture of components A and B, were determined at a shear rate of 0.89 s⁻¹. The viscosity and yield point values indicated in Table 1 refer to the mixture of A and B. For the measurement, the samples of the respective components A and B of the two-component silicone formulation were applied immediately after mixing, without further additives or processing steps.

The yield point was determined at 23° C./50% relative humidity on a Physica MCR101 type rheometer from Anton Paar using a cone and plate system. For this purpose, an oscillation test was carried out at a constant angular frequency of w=10 s⁻¹ and a deformation of y=0.01 up to 100% with 6 measurement points in each case per decade. The yield point is obtained as shearing strain during the start of the drop of the curve of the storage modulus.

### Slip Down

The slip down was measured at 23° C./150% relative humidity. For this purpose, beads measuring 70×12×5 mm (L×W×H) were applied to a web made of anodized aluminum. The aluminum web was applied perpendicularly to a glass plate made of float glass and pressed on up to a distance of 3 mm. The slip down was determined 24 hours as slip of the aluminum web from the starting position.

TABLE 1

| | Example 1 | Example 2 | Example 3 | Example 4 | Example 5 | Example 6 | Example 7 |
|---|---|---|---|---|---|---|---|
| OH-terminated poly(dimethylsiloxane)* | 36.8 | 39.36 | 48.4 | 51.6 | 48.2 | 50.1 | 28.1 |
| Trimethylsilyl-terminated poly(dimethyl- | 9.4 | 11.3 | 3.8 | 3.9 | 3.6 | 3.8 | 11.0 |
| siloxane)** | | | | | | | |
| Octyltrimethoxysilane | 4.0 | 1.9 | 3.5 | 3.0 | 3.4 | 3.5 | 2.8 |
| Bis(triethoxysilyl)ethane | | 1.8 | 0.9 | 1.4 | 0.9 | 0.9 | |
| EO-PO-EO triblock copolymer*** | | | | | | | 1.4 |
| EO-PO-functionalized ethylene diamine**** | 1.4 | 1.4 | 0.4 | 1.4 | 0.6 | 0.4 | 3.6 |
| Carbon black (D50: 56 nm, BET: 45 m²/g) | 1.1 | 0.6 | 1.7 | 1.7 | 1.8 | 1.7 | |
| Pyrogenic silica (D50: 10 nm, BET: 100 m²/g) | 0.8 | 0.9 | 7.2 | 5.0 | 6.6 | 6.3 | |
| Precipitated chalk (D50: 80 nm, BET: 17 m²/g) | 18 | 34.9 | 25.4 | 18.2 | 28.5 | 28.8 | |
| Al(OH)₃ (D50: 1.3 μm, BET: 3.5 m²/g) | | | 4.3 | 6.8 | 4.3 | 4.4 | |
| Natural chalk (D50: 6 μm) | 28.0 | 7.8 | 4.4 | 6.8 | 2.2 | | 53.1 |
| Dioctyl-Sn diketanoate (21% by weight Sn) | 0.56 | 0.04 | 0.10 | 0.09 | 0.06 | 0.06 | 0.03 |
| Ratio fine:coarse fillers | 1:1.4 | 4.7:1 | 4:1 | 1.8:1 | 5.7:1 | 8.4:1 | |
| Slip down [mm] | 3 | 0 | 0 | 4 | 0.3 | 0 | s.d. |
| Yield point [Pa] | 74 | 72 | 38 | nd | nd | nd | 83 |
| Viscosity [Pa * s] | 1,100 | 1,200 | 2,100 | 1,700 | 2,500 | 2,400 | 1,550 |
| Tensile strength (7 d 23/50) [MPa] | 1.1 | 1.04 | 1.1 | 1.00 | 1.18 | 1.01 | 0.4 |
| Tensile strength (21 d 55° C. water bath, hv) | 0.6 | 1.1 | 1.08 | 0.74 | 1.17 | 1.02 | 0.2 |
| [MPa] | | | | | | | |
| Change in tensile strength | −45% | +6% | +2% | −26% | −1% | +1% | −50% |

Formulation constituents are % w/w and based on the total formulation (A + B mixed);
s.d.: slips down;
nd: not determined
*Viscosity 20,000 mPas
**Viscosity 100 mPas
***Viscosity 200 mPas (50° C., according to ISO 53015), flow point 14° C. (according to ISO 3016)
****Viscosity 500 mPas (20° C., according to ISO 53015), cloud point 73-79° C. (according to DIN 23015)

1. A one- or two-component silicone formulation, comprising constituents:
a) at least one poly(diorganosiloxane);
b) at least one first filler having an average particle size D50 less than or equal to 0.1 μm;
c) at least one second filler having an average particle size D50 greater than 0.1 μm to 10 μm; and
d) at least one cross-linking agent for the poly(diorganosiloxane);
wherein the constituents are present in one component in the case of the one-component silicone formulation, and are divided into two components A and B in the case of the two-component silicone formulation.

2. The one- or two-component silicone formulation according to claim 1, wherein the weight ratio of the first filler to the second filler is in the range of 10:1 to 1:2.

3. The one- or two-component silicone formulation according to claim 1 wherein the at least one poly(diorganosiloxane) comprises or is at least one OH-terminated poly(diorganosiloxane) and/or at least one alkoxysilyl-terminated poly(diorganosiloxane).

4. The one- or two-component silicone formulation according to claim 1, wherein the at least one poly(diorganosiloxane) has a viscosity in the range of 10 mPas to 500,000 mPas at 23° C.

5. The one- or two-component silicone formulation according to claim 1, wherein the at least one cross-linking agent is selected from the group consisting of tetraalkoxysilane, organotrialkoxysilane, diorganodialkoxysilane and oligo(organoalkoxysilane), tetrakis ketoximosilane, organotris ketoximosilane, diorganobis ketoximosilane, oligo(organoketoximosilane), and mixtures thereof.

6. The one- or two-component silicone formulation according to claim 1, further comprising:
e) at least one condensation catalyst.

7. The one- or two-component silicone formulation according to claim 1, further comprising:
f) at least one additive selected from the group consisting of plasticizers, rheology auxiliaries, thickeners, adhesive promoters, catalysts, accelerators, drying agents, odorants, pigments, biocides, stabilizers and surfactants.

8. The one- or two-component silicone formulation according to claim 1, wherein the formulation is a two-component silicone formulation, wherein the constituents a), b) and c) and, if necessary, an optional additive or additives f), which is selected from the group consisting of plasticizers, rheology auxiliaries, thickeners, adhesive promoters, catalysts, accelerators, drying agents, odorants, pigments, biocides, stabilizers and surfactants, are present in the first component A, and constituent d) and, if necessary, an optional constituent e), which is at least one condensation catalyst, are present in the second component B.

9. The one- or two-component silicone formulation according to claim 1, wherein the formulation furthermore comprises an additive selected from the group consisting of end-capped silicone oil, amino-functionalized organotrialkoxysilane, epoxy-functionalized organotrialkoxysilane, mercapto-functionalized organotrialkoxysilane, amino-functionalized oligosiloxane, polyamine, polyether, heteropolyether and polyetheramine.

10. The one- or two-component silicone formulation according to claim 1, wherein the formulation is an RTV silicone formulation.

11. The one- or two-component silicone formulation according to claim 1, wherein the formulation is a moisture-curing and/or free-flowing silicone formulation.

12. The one- or two-component silicone formulation according to claim 1, wherein a plurality of fillers is used for the first filler.

13. The one- or two-component silicone formulation according to claim 1, wherein one or more fillers with the average particle size D50 of the primary particles being 5 nm to 100 nm are used for the first filler, and/or wherein one or more fillers in which the average particle size D50 of the primary particles is 0.5 μm to 10 μm are used for the second filler.

14. The one- or two-component silicone formulation according to claim 1, wherein at least one poly(diorganosiloxane) is one or more polydiorganosiloxanes having the formula (I), 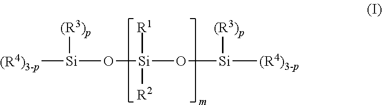
where
the groups R¹, R² and R³ independently of one another represent linear or branched monovalent hydrocarbon groups having 1 to 12 carbon atoms, which optionally include one or more heteroatoms, and optionally one or more carbon-carbon multiple bonds and/or optionally cycloaliphatic and/or aromatic fractions or groups; the groups R⁴ independently of one another represent hydrogen, hydroxyl groups, or alkoxy, acetoxy or ketoxime groups, each having 1 to 13 carbon atoms, which optionally include one or more heteroatoms, and optionally one or more carbon-carbon multiple bonds and/or optionally cycloaliphatic and/or aromatic fractions or groups, wherein the groups R⁴ preferably represent hydroxyl groups or alkoxy groups; the subscript p represents a value of 0, 1 or 2; and the subscript m is selected so that the poly(diorganosiloxane) has a viscosity of 10 mPas to 500,0004 mPas at a temperature of 23° C.

15. A method of making an elastic adhesive, the method comprising making the elastic adhesive by adding the one- or two-component silicone formulation according to claim 1, wherein the elastic adhesive can be used for structural adhesive attachment, optionally in the facade, insulated glass, window construction, automotive, solar and construction fields.

16. A method of filling a space between two substrates so as to create an arrangement, the method comprising:
a) providing a silicone formulation according to claim 1, wherein the two components are mixed with each other in the case of a two-component silicone formulation;
b1) applying the one-component silicone formulation, or the mixed two-component silicone formulation, to a first substrate, and bringing a second substrate in contact with the silicone formulation that has been applied to the first substrate; or
b2) filling a space formed by the arrangement of a first substrate and a second substrate with the one-component silicone formulation, or with the mixed two-component silicone formulation; and
c) curing the silicone formulation.

17. The method according to claim 16, wherein the silicone formulation or, in the case of the two-component silicone formulation, the mixture of the two components has a viscosity in the range of 500 Pas to 5,000 Pas at 23° C. when it is applied to the first substrate or filled into the space formed between the two substrates.

18. The method according to claim 16, wherein the silicone formulation or, in the case of the two-component silicone formulation, the mixture of the two components has a yield point of less than 150 Pa when it is applied to the first substrate or filled into the space formed between the two substrates.

19. The method according to claim 16, wherein the silicone formulation is a two-component silicone formulation.

20. An arrangement, comprising a cured silicone formulation, which fills a space between two substrates, obtained according to the method according to claim 16.

21. The one- or two-component silicone formulation according to claim 2, wherein the weight ratio of the first filler to the second filler is 10:1 to 1:1.

22. The one- or two-component silicone formulation according to claim 2, wherein the weight ratio of the first filler to the second filler is 10:1 to 2:1.

23. The one- or two-component silicone formulation according to claim 2, wherein the weight ratio of the first filler to the second filler is 9:1 to 3:1.

24. The one- or two-component silicone formulation according to claim 2, wherein the weight ratio of the first filler to the second filler is 8:1 to 4:1.

25. The one- or two-component silicone formulation according to claim 4, wherein the viscosity of the at least one poly(diorganosiloxane) is 5,000 mPas to 350,000 mPas at 23° C.

26. The one- or two-component silicone formulation according to claim 13, wherein the average particle size D50 of the primary particles of the one or more fillers used for the second filler is 1 μm to 8 μm.
